(19) United States
(12) Patent Application Publication
(10) Pub. No.: US 2008/0065620 A1
(43) Pub. Date: Mar. 13, 2008

(54) Recommending advertising key phrases

(76) Inventor: Puneet Chopra, Fremont, CA (US)

Correspondence Address: FISH & RICHARDSON P.C., PO BOX 1022, MINNEAPOLIS, MN, 55440-1022, US

(21) Appl. No.: 11/519,277

(22) Filed: Sep. 11, 2006

(51) Int. Cl. G06F 7/00

(52) U.S. Cl. 707/5

(57) ABSTRACT

Methods, systems, and apparatus, including computer program products for generating key phrases for advertising are provided. In one implementation, a method is provided. The method includes receiving input from an advertising user specifying an advertisement that is associated with a particular landing page. A key phrase for the advertisement is automatically generated, the key phrase being generated based on features extracted from the landing page and based on empirical statistics derived from a corpus comprising corpus key phrases and web pages corresponding to the respective corpus key phrases.

### TECHNICAL FIELD

This invention relates to machine learning for recommending online advertising key phrases.

### BACKGROUND

In a typical online advertising system, advertisers specify key phrases for their ads. A key phrase is a set of one or more words which can be matched against, for example, a user's query to a search engine. A particular ad can be eligible to be shown to a user in response to the query based on whether the query matches one or more of the key phrases associated with the particular ad.

When a user queries the search engine, the advertising system determines which key phrases match the user's query. For example, a query for “natural shaving oil” might match the key phrases “shaving,” “shaving oil,” and “natural shaving oil,” but not match the key phrase “ferret feed.” The ads corresponding to one or more identified key phrases become eligible to be displayed to the user with the search results. There may be many ads (perhaps thousands, or even more) associated with each key phrase. For example, ads corresponding to the key phrase of “shaving” can include ads titled “Shaving Better” and “New Triple-Action Razor,” associated with web pages ShavingBetter.com and ThreeWhisketeers.com, respectively. The more specific key phrases “shaving oil” and “natural shaving oil” may also have corresponding ads.

All of these ads become eligible to be displayed to the user because the key phrases corresponding to the ad matched the user's query. However, ads corresponding to non-matching key phrases are not eligible to be displayed.

The advertising system determines which of the eligible ads should actually be displayed to the user, a process which could be based on several different factors. For example, the advertising system can rely on the popularity of the ads, so that more popular ads are displayed more often. Alternatively, the advertising system can rely on a computerized bidding process based on what the advertisers have stated they are willing to pay, so that advertisers willing to pay more are more likely to have their ad displayed.

The user is then presented with a list of ads, along with the results of their search query. If the user selects one of the ads, such as by clicking with a mouse, the user can be taken to a web page specified in the ad. This web page is called a landing page.

Advertisers generally want to target their ads to users interested in what they are offering. The key phrases should match relevant queries and not match irrelevant queries.

### SUMMARY

Methods, systems, and apparatus, including computer program products for generating advertising key phrases are provided. In general, in one aspect, a method is provided. The method includes receiving input from an advertising user specifying an advertisement that is associated with a particular landing page. A key phrase for the advertisement is automatically generated, the key phrase being generated based on features extracted from the landing page and based on empirical statistics derived from a corpus comprising corpus key phrases and web pages corresponding to the respective corpus key phrases. Other implementations of this aspect feature corresponding systems and computer program products.

These and other implementations can optionally include one or more of the following features. In one implementation, the corpus key phrases include key phrases for other advertisements and the corresponding web pages in the corpus include landing pages corresponding to the key phrases. In another implementation, the corpus key phrases in the corpus include queries received by a search engine from users and the corresponding web pages in the corpus include web pages whose corresponding search results were presented by the search engine in response to the queries and then selected by the respective users.

In general, in another aspect, embodiments of the technologies feature methods, systems, and apparatus, including computer program products. The method includes obtaining a corpus of key phrases, web pages, and click-through rates. Each key phrase provides access to one or more corresponding web pages. Each web page corresponds to a click-through rate, the click-through rate being a fraction of the number of times a hyperlink to the web page is presented to users that the hyperlink is selected by the users. The click-through rates are grouped into buckets. The method includes extracting features from the web pages. The method also includes obtaining a set of first empirical probabilities, a set of second empirical probabilities, and a mapping of features to key phrases. Each first empirical probability, \hat{P}(kⱼ|fᵢ), is a fraction of web pages with a particular feature fᵢ that correspond to a particular key phrase kⱼ. Each second empirical probability, \hat{P}(CTR_{b}|fᵢ∩kⱼ), is a fraction of web pages with a particular feature f and reached through a particular key phrase kⱼ that correspond to a particular click-through rate bucket CTR_{b}. The mapping associates features and key phrases, each feature being associated with the respective key phrases corresponding to web pages containing the feature. Other implementations of this aspect include corresponding systems and computer program products.

In general, in another aspect, embodiments of the technologies feature methods, systems, and apparatus, including computer program products. The method includes receiving input from an advertising user specifying an advertisement that is associated with a particular landing page. Features are extracted from the landing page. Corresponding weights are assigned to each feature of the plurality of features. A collection of key phrases is identified corresponding to the plurality of features. Each identified key phrase of the collection is scored, the scoring being at least in part based on one or more empirical probabilities derived from a corpus comprising web pages. Other implementations of this aspect include corresponding systems and computer program products.

These and other implementations can optionally include one or more of the following features. Scoring a key phrase includes calculating a nested summation of an outer summation and an inner summation. The outer summation of one or more outer summands is calculated over the features. Each outer summand for each feature is a product of the weight corresponding to the feature, a first empirical probability \hat{P}(kⱼ|fᵢ) for each key phrase kⱼ and each featured, and the inner summation for the key phrase and the feature. The inner summation of one or more inner summands for the key phrase and the feature is calculated over click-through buckets, each inner summand being the product of a weight for the click-through bucket and a second empirical probability \hat{P}(CTR_{b}|∩kⱼ) for the key phrase kⱼ, the feature fᵢ and the click-through bucket CTB_{b}.

The details of the various aspects of the subject matter described in this specification are set forth in the accompanying drawings and the description below. Other features, objects, and advantages of the subject matter will be apparent from the description and drawings, and from the claims.

### DESCRIPTION OF DRAWINGS

FIG. 1 shows an example process for heuristically generating key phrases for a specified landing page.

FIG. 2 shows an example process for deriving empirical probabilities from a corpus of key phrases, web pages, and quality measurements.

FIG. 3 shows an example process for using empirical probabilities to heuristically generate key phrases for a specified landing page.

FIG. 4 shows an example of deriving empirical probabilities from a corpus of key phrases, web pages, and quality measurements.

FIG. 5 shows an example of using empirical probabilities to heuristically generate key phrases for a specified landing page.

Like reference symbols in the various drawings indicate like elements.

### DETAILED DESCRIPTION

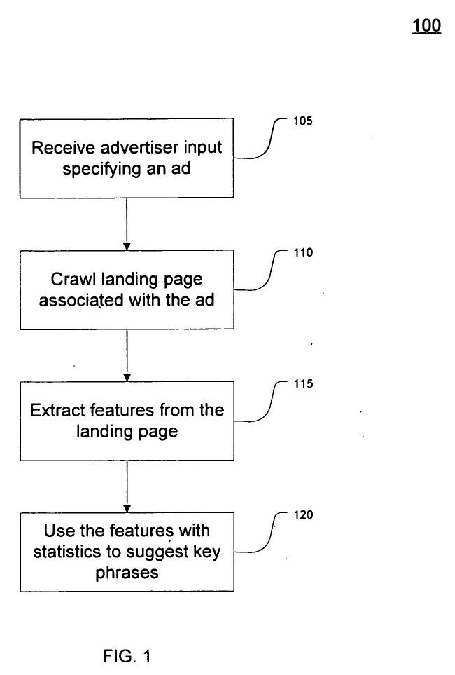

FIG. 1 shows an example process 100 for heuristically generating key phrases for a specified landing page. For convenience, the process will be described with reference to an advertising system that performs the process.

The advertising system receives user input (e.g., from an advertiser) specifying an ad (step 105). The ad is associated with a landing page. For example, the user may have an online store selling go-go boots. The user can define an ad in the advertising system, setting the landing page of the ad to be the web page of the online go-go boot store. The user can then request the advertising system to suggest key phrases for the ad. The ad specification and request for a suggestion constitute user input that the advertising system receives.

The advertising system crawls the landing page (step 110). For example, the advertising system can use the HTTP protocol to download a copy of the landing page from the user's own server. Previously, the advertising system may have only been supplied with a hyperlink to the landing page. After crawling the landing page, the advertising system has a copy of the landing page itself.

The advertising system extracts features from the landing page (step 115). The advertising system can strip off boilerplate, for example by comparing the landing page to other pages on the user's server. The advertising system can also strip out stop words (e.g., “a,” “an,” and “the,” in English). After discarding useless information from its copy of the landing page, the advertising system can extract useful features from the remaining content of the landing page. The useful features can be n-grams, for example. n-grams are phrases of n words occurring in the text. In the text, “How now, brown cow,” the advertising system could extract different n-grams, including unigrams (n=1), bigrams (n=2), and trigrams (n=3): “how,” “now,” “brown,” “cow,” “how now,” “now brown,” “brown cow,” “how now brown,” and “now brown cow.” The advertising system can extract other kinds of features, depending on how the advertising system is programmed. For example, the advertising system can use image recognition technology to infer the subject matter of pictures on the landing page.

The advertising system uses the features, as well as statistics derived from a corpus of key phrases, web pages, and quality measurements, to suggest one or more key phrases for the ad (step 120). (The word “corpus” is a term of art in computational linguistics, referring to a large and structured set of texts.) The advertising system is likely to have documents with at least some similarity to the landing page in the corpus. In the go-go boot example, the corpus can contain web pages from other online stores selling go-go boots. Using statistics generated from these similar documents, the advertising system generates key phrases to suggest to the user.

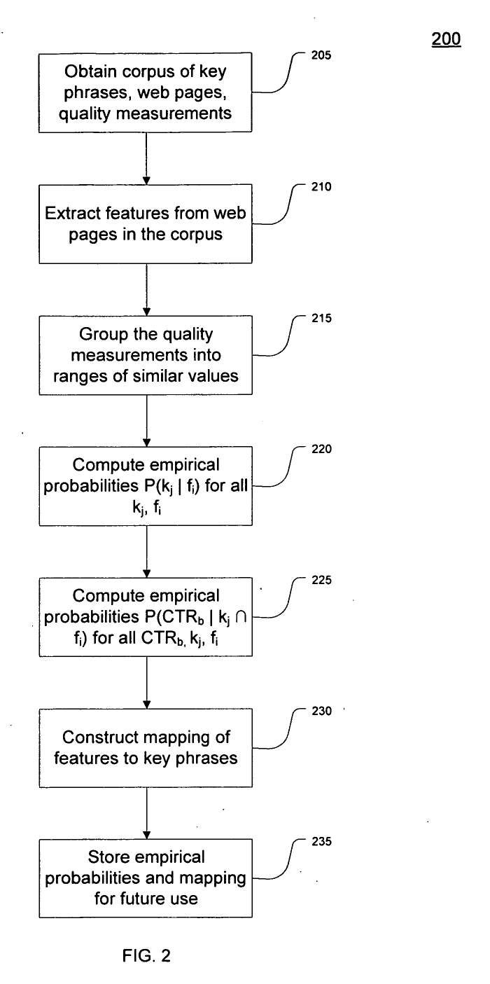

FIG. 2 shows an example process 200 for deriving empirical probabilities from a corpus of key phrases, web pages, and quality measurements. These empirical probabilities could be some of the statistics depicted in FIG. 1. The process 200 will be called “training.”

The advertising system obtains a corpus of key phrases, web pages, and quality measurements (step 205). Each key phrase corresponds to one or more web pages, and the web pages are reachable through the key phrase. For example, the key phrase could be a search phrase for which the search engine lists the web pages as results. The key phrase could also be a key phrase for ads for which the web pages are landing pages.

One well-known quality measurement for ads and search results is a click-through rate. In one implementation of the advertising system, each ad and search result has a corresponding click-through rate. The click-through rate is the fraction of the number of times an ad or search result including a hyperlink to the web page is presented to users (e.g., as part of an ad, or as part of a list of search results) that the hyperlink is selected by the users. Other quality measurements can be used, such as the length of time that users tend to visit the web page. This length of time, or “long click,” can be measured by techniques set out below. Others are the cost per click or cost per conversion for an ad.

In one implementation, the corpus is constructed by choosing about one million ads at random from a database. Each ad is associated with one or more key phrases, a landing page, and a click-through rate. Collectively, the key phrase, landing pages, and click-through rates constitute part of the corpus's key phrases, web pages, and quality measurements.

Alternatively, user queries to the search engine can be used to construct the corpus (alone or in addition to ad data). That is, the search engine can maintain a database of historical queries made by users, together with the web pages selected by the users after making the queries. The search engine can also determine the click-through rate of the selected web pages, based on how often the web pages were selected with respect to how often the web pages were returned in search query results. Collectively, these user queries, selected web pages, and click-through rates constitute part of the corpus's key phrases, web pages, and quality measurements.

A variety of techniques can be used to construct the database of historical queries with the web pages selected by users in response to the query results. Normally, the publisher of a web page that links to a second web page cannot determine whether a user follows the link to the second web page. The search engine, however, can use redirection to accurately determine which results are chosen by users. Rather than providing a list of results with URLs pointing to the intended web pages, the search engine can provide a list of results with URLs pointing to the search engine's servers. Thus, once a user selects a result, the search engine has an opportunity to record the selected result before sending the user to the intended web page. The search engine can limit this redirection to a small but statistically significant fraction of users to protect users' privacy.

Another way for the search engine to monitor which results are selected by users is to encourage users to install browser add-ins that monitor which search results are selected in the browser. Cookies can also be used with some degree of success to track users. For example, an advertising system that is affiliated with the search engine can broker ads to many independent web sites. Each time a user visits one of these independent web pages, a cookie can be transmitted to the advertising system. A cookie can also be transmitted to the search engine when a user submits a query. The cookies transmitted to the search engine can be correlated with the cookies transmitted to the advertising system, to determine which web pages users select from the lists of results returned by the search engine. The same techniques work for determining long clicks.

The corpus can also be constructed using data from shopping services. The corpus can also be constructed from a combination of these data sources, for example having a “sub-corpus” of web search data and a sub-corpus of advertiser data. It can be advantageous to keep the data sources separate within the corpus, because the data are not necessarily comparable across data sources.

The advertising system extracts features from the web pages in the corpus (step 210). The feature extraction can occur the same as described in step 115 in FIG. 1, above.

In one implementation of the training process, the advertising system groups the quality measurements, such as the click-through rates, by grouping ranges of similar values together (step 215). For example, all the click-through rates could be put into five different buckets. Certain calculations become simpler and more robust if the quality measurements are grouped together. However, it is also acceptable to leave the quality measurements ungrouped by bucketing only identical values.

As previously stated, the corpus contains web pages and key phrases, and each web page corresponds to one or more key phrases. The advertising system computes a set of empirical probabilities \hat{P}(kⱼ|fᵢ), for each key phrase kⱼ and each featured fᵢ (step 220). This is simply the fraction of web pages in the corpus with feature fᵢ that correspond to key phrase kⱼ. For example, consider a corpus constructed of a mixture of advertiser data and web search data. Assume the corpus includes 1000 web pages each with a feature being the bigram “how now.” These web page can be a mixture of landing pages and web pages listed as search results in response to submitting queries to a search engine. Of these 1000 web pages, 106 are advertiser landing pages where the advertiser used the key phrase “brown cow.” Additionally, 314 are web pages listed as search results in response to submitting the query “brown cow” to a search engine. In this example, where kⱼ=“brown cow” and fᵢ=“how now,” the empirical probability \hat{P}(kⱼ|fᵢ)=(106+314)/1000=420/1000, or 0.42. The empirical probability is calculated for every combination of key phrase and feature in the corpus.

In another implementation, the corpus keeps the advertiser data and web search data separate. Assume that there are 333 web pages that are landing pages and that there are 667 web pages visited by users in response to submitting queries to a search engine. Using the same numbers as the previous example, 106 of the 333 and 314 of the 667 contain the featured fᵢ=“how now,” and all of the 333 and 667 were reached with the key phrase kⱼ=“brown cow.” The empirical probabilities \hat{P}(kⱼ|fᵢ) are therefore 106/333=0.32, and 314/667=0.47.

The advertising system also computes a set of empirical probabilities based on the quality measurements. In one implementation, the quality measurements are click-through rates grouped into buckets: up to 0.75% is the “lowest” click-through rate bucket, 0.75% up to 1.25% is the “low to medium” click-through rate bucket, 1.25% up to 2.00% is the “medium” click-through rate bucket, 2.00% up to 4.00% is the “medium to high” click-through rate bucket, and 4.00% and higher is the “high” click-through rate bucket. The empirical probability \hat{P}(CTR_{b}|fᵢ#kⱼ) is computed for each click-through rate bucket CTR_{b}, each featured, and each key phrase kⱼ (step 225). In the previous example, there were 420 web pages in the corpus with the feature “how now” and the key phrase “brown cow.” Of these, 239 might have a click-through rate greater than four percent, and for this example they can grouped into a bucket. The resulting empirical probability would be 239/420=0.57. The empirical probability is calculated for every combination of feature, key phrase, and click-through rate bucket.

More generally, any quality measurement can be used instead of the click-through rate, such as a long click measurement, or cost per click or conversion. The score can also be based on multiple quality measurements. For example, the advertising system may be implemented to favor key phrases that both perform well, as indicated by having a high click-through rate, and are cheap, as indicated by having a low cost per click. This advertising system can bucket both the click-through rates and the cost per clicks. The advertising system can compute \hat{P}(CTR_{b}|fᵢ∩kⱼ) as before. The advertising system can also calculate a joint empirical probability \hat{P}(CTR_{b}∩CPC_{c}|fᵢ∩kⱼ) for each click-through rate bucket CTR_{b}, each cost per click bucket CPC_{c}, each feature fᵢ, and each key phrase kⱼ, as well as \hat{P}(CPC_{c}|CTR_{b}∩fᵢ∩kⱼ).

The advertising system constructs a mapping of features to key phrases (step 230). Each feature in the corpus occurs in one or more web pages. For example, “how now” might occur in 1000 web pages. Each of the web pages has one or more corresponding key phrases, such as “brown cow.” All of these key phrases are collected together, so that the mapping can be used to determine which key phrases correspond to the feature “how now.” In this example, “brown cow” would be one of them. The mapping is constructed for all features. The mapping can be implemented as a hash table, search tree, or database, whether distributed across several servers or stored on a single server. One implementation uses a hash table distributed across several servers.

The advertising system stores the two sets of empirical probabilities and the mapping for future use (step 235).

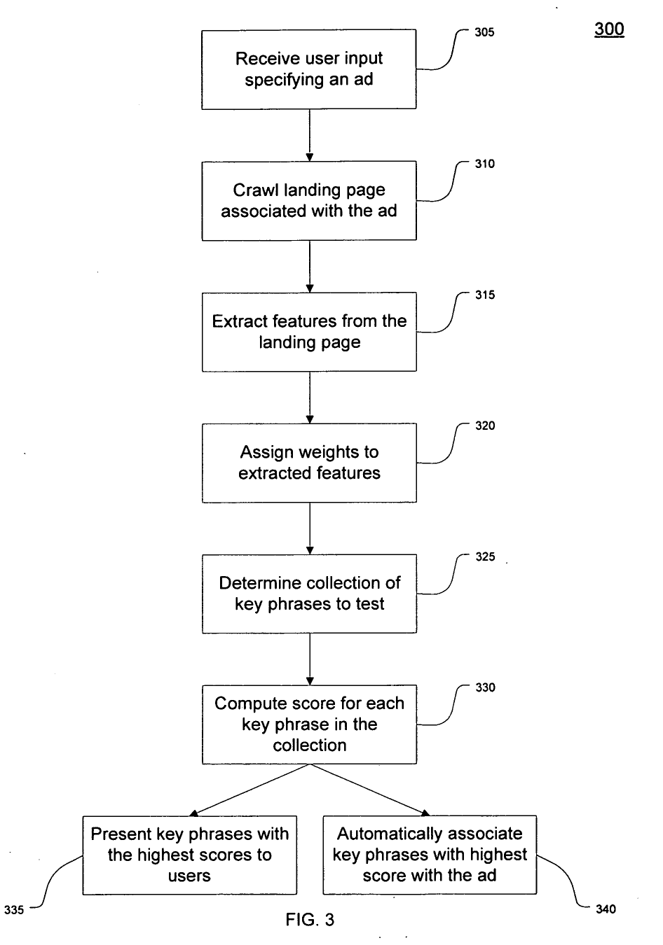

FIG. 3 shows an example process 300 for using empirical probabilities to heuristically generate key phrases for a specified landing page.

The advertising system receives user input specifying an ad (step 305). The ad is associated with a landing page. The advertising system crawls the landing page (step 310). The advertising system extracts features from the landing page (step 315). These steps can occur in a similar manner to that described in reference to steps 105, 110, and 115 of FIG. 1.

The advertising system assigns weights wᵢ to the features extracted from the landing page (step 320). The weights can be specific to the landing page, describing the importance of the particular features on that landing page. For example, the bigram feature “Kobe beef” could be very important on a web page for a store selling imported wagyuu beef from Kobe, Japan. The same feature could be less important on a web page detailing basketball superstar Kobe Bryant's beef with former teammate Shaquille O'Neal. A tf-idf (term frequency, inverse document frequency) weight can determine the relative importance of the feature on the specified landing page, compared to the importance of the feature in a corpus of documents. The corpus used to calculate tf-idf need not be the corpus used to calculate the empirical statistics. (The corpus used to calculate the empirical statistics may be discarded once the training phase calculations, described in reference to FIG. 2, are complete.) One way to determine tf-idf is to calculate:

$$tf ( {t}_{i} ) = \frac{{n}_{i}}{{\sum }_{j}^{ } {n}_{j}} and ifd ( {t}_{i} ) = log \frac{N}{{df}_{i}} , then tfidf ( {t}_{i} ) = tf ( {t}_{i} ) \cdot idf ( {t}_{i} ) ,$$

where nᵢ, the numerator in tf is the number of occurrences of featuref in the specified landing page. The denominator in tf is the number of occurrences of all features in the specified landing page; thus tf is a relative frequency. The numerator in idf is the total number of documents in the corpus, and the denominator is the number of documents in the corpus containing the term. For this formula to be mathematically well defined, the corpus should include the specified landing page, so that the denominator of idf is never zero. However, slight modifications can be made to the formula so that the corpus need not contain the specified landing page.

The weights can be determined based on the prominence of the feature on the web page, such as font, color, location, or number of occurrences. Other factors for determining the weight can include whether the feature was used as anchor text for a hyperlink. If the default weighting system favors simple features, such as unigrams, at the expense of complex features, such as trigrams, the weights can be adjusted to compensate. One way to compensate is to add or multiply the weights of constituent features with the weights of composite features to determine the overall weight of each complex feature. For example, a trigram can be considered to be a composite of three constituent unigrams. If the weight of the trigram “now brown cow” were 8, and the weights of “now,” “brown,” and “cow” were 13, 9, and 12, the weight of “now brown cow” could be increase by 13+9+12, resulting in an adjusted weight of 42.

The advertising system determines a collection of candidate key phrases (step 325). The advertising system has a list of features extracted from the landing page. The mapping from the training phase, see step 230, FIG. 2, accepts a feature and returns a list of key phrases from web pages containing that feature. By looking up all of the features, the advertising system obtains a list of candidate key phrases associated with features from the landing page.

The advertising system computes a score for each key phrase in the collection (step 330). In one implementation, the score sⱼ for kⱼ is calculated as:

$${\sum }_{i = 1}^{n} {w}_{i} \cdot \hat{P} ( {k}_{j} \text{\textbar} {f}_{i} ) \cdot {\sum }_{b = 1}^{B} g ( {CTR}_{b} ) \cdot \hat{P} ( {CTR}_{b} \text{\textbar} {f}_{i} ⋂ {k}_{j} )$$

where n is the number of features fᵢ on the specified landing page as well as the number of weights wᵢ. CTR_{b} and the empirical probabilities \hat{P}(kⱼ|fᵢ) and \hat{P}(CTR_{b}|fᵢ∩kⱼ) are calculated as above. B is the number of click-through rate buckets. g(CTR_{b}) is a weight function for the click-through rate buckets; a “bucket,” however, is not a number and therefore the g(·) function is used at least from a formal mathematical standpoint to convert the buckets into numbers for purposes of arithmetic. Additionally the g(·) function can emphasize or deemphasize web pages in the corpus with high click-through rates. If the g(·) function assigns a high value to high click-through rate buckets, key phrases kⱼ which are found in the corpus with web pages containing features from the specified landing page will tend to receive higher scores sⱼ. In another implementation, the click-through rates are not bucketed, and therefore the g(·) function is unnecessary.

The score can also be calculated based on multiple quality measurements. In an implementation that uses both click-through rates and costs per click, the score sⱼ for kⱼ can be calculated as:

$${\sum }_{i = 1}^{n} {w}_{i} \cdot \hat{P} ( {k}_{j} \text{\textbar} {f}_{i} ) \cdot {\sum }_{b = 1}^{B} g ( {CTR}_{b} ) \cdot \hat{P} ( {CTR}_{b} \text{\textbar} {f}_{i} ⋂ {k}_{j} ) \cdot {\sum }_{c = 1}^{C} h ( {CPC}_{c} ) \cdot \hat{P} ( {CPC}_{c} \text{\textbar} {CTR}_{b} ⋂ {f}_{i} ⋂ {k}_{j} )$$

where the variables are as above, with the addition of C, the number of cost-per-click buckets; h(CPC_{c}), a weight function for the cost-per-click buckets; and \hat{P}(CPC_{c}|CTR_{b}∩fᵢ∩kⱼ), defined above.

The score can be intuitively understood as answering this question: “If the empirical probabilities were independent of the landing pages and each other (with respect to the features), and the corpus were a result of randomly assigning key phrases to web pages according to a probability distribution defined by the empirical probabilities, which key phrases would be most likely to be assigned to the user's selected landing page?” The assumptions are in fact not true, however, the calculations are robust and work in spite of false assumptions like these.

The advertising system can present one or more key phrases kⱼ with the highest scores sⱼ to the user (step 335). The user can then decide whether to use the key phrases as key phrases for the specified ad. Alternatively, the advertising system can automatically associate one or more key phrases kⱼ with the highest scores sⱼ with the specified ad (step 340).

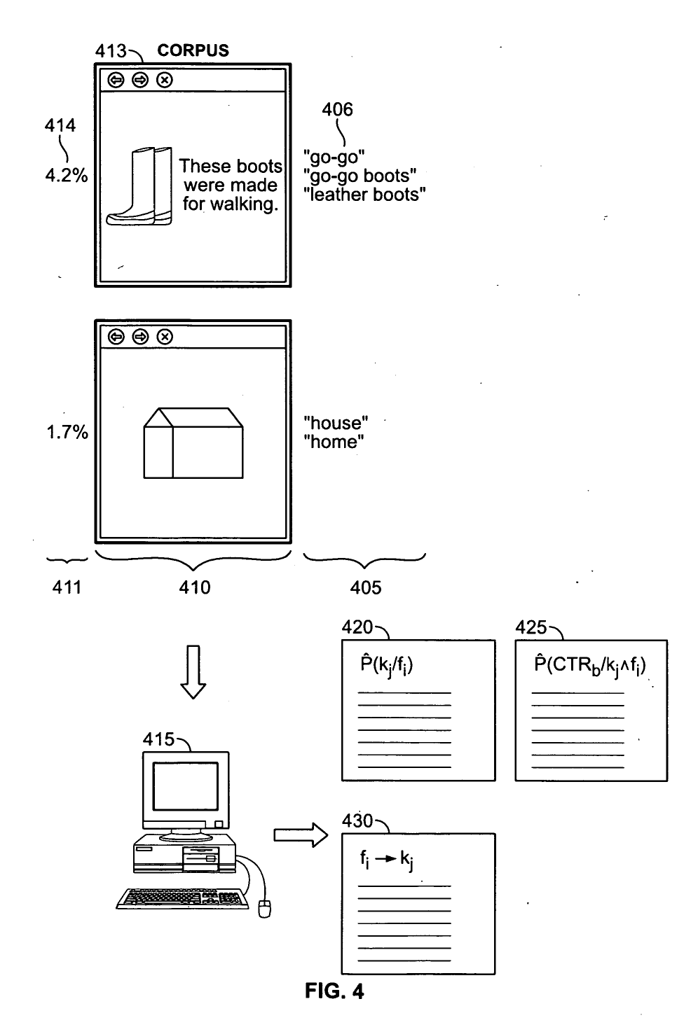

FIG. 4 shows an example of deriving empirical probabilities from a corpus. In this example the corpus only includes advertising data and the quality measurements of the web pages are limited to click-through rates. The corpus has key phrases 405 and landing pages 410 corresponding to click through rates 411. There may be several key phrases for each landing page. For example, an advertiser selling go-go boots might choose the key phrases “go-go,” “go-go boots,” and “leather boots.” In this example one ad has a click-through rate 414 of 4.2%, which might be considered better than average.

A computer 415 processes the corpus key phrases 405 and landing pages 410 corresponding to click-through rates 411. Depending on the size of the corpus, a large computer or even a cluster of computers may be commended to process the data.

The computer processing results in first empirical probabilities \hat{P}(kⱼ|fᵢ) 420, second empirical probabilities \hat{P}(CTR_{b}|fᵢ∩kⱼ) 425, and a mapping of features to key phrases 430. All three of these can be stored in distributed hash tables. The first empirical probabilities \hat{P}(kⱼ|fᵢ) 420 can be keyed off the features fᵢ. The second empirical probabilities \hat{P}(CTR_{b}|fᵢ∩kⱼ) 425 can be jointly keyed off the features fᵢ and kⱼ. The mapping of features to key phrases 430 can be keyed off the features fᵢ. In the go-go boots example, one landing page 413 in the corpus contained the text “These boots were made for walking.” Two features that could be extracted from this text are the n-grams “made for” and “made for walking.” The corresponding key phrases for this landing page 413 were the key phrases “go-go,” “go-go boots,” and “leather boots” 406. Therefore, in the mapping of features to key phrases 430, looking up the feature “made for” returns “go-go,” “go-go boots,” and “leather boots.” The same is true for looking up the feature “made for walking.”

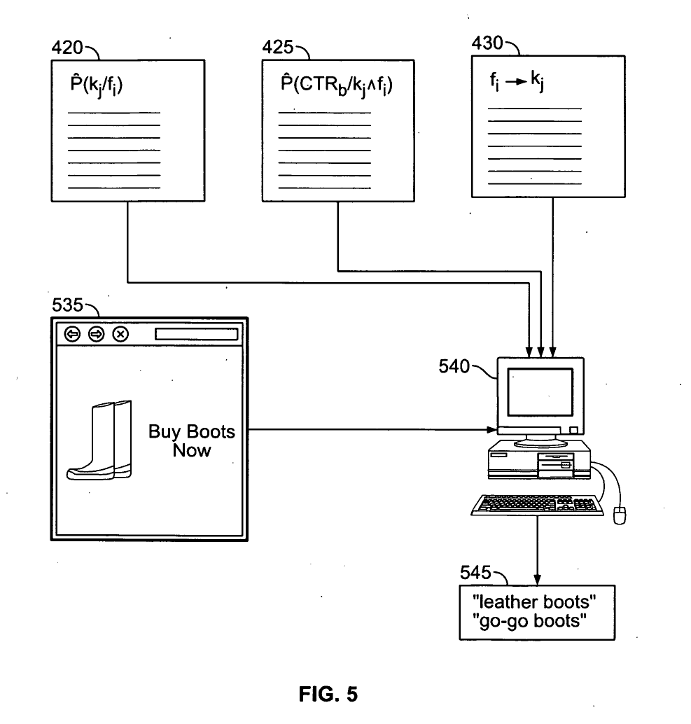

FIG. 5 illustrates how empirical probabilities can be used to heuristically generate key phrases for a specified landing page. The first empirical probabilities \hat{P}(kⱼ|fᵢ) 420, the second empirical probabilities \hat{P}(CTR_{b}|fᵢ∩kⱼ) 425, and the mapping of features to key phrases 430 created in FIG. 4 are used by a computer 540. The computer 540 reads a specified landing page 535 and outputs a list of key phrases 545 as suggested key phrases to use with the landing page.

The various aspects of the subject matter described in this specification and all of the functional operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer program products, i.e., one or more modules of computer program instructions encoded on a computer-readable medium for execution by, or to control the operation of; data processing apparatus. The instructions can be organized into modules in different numbers and combinations from the key phrase modules described. The computer-readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Various aspects of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the

While this specification contains many specifics, these should not be construed as limitations on the scope of what may be claimed, but rather as descriptions of features specific to particular implementations of the subject matter. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

The subject matter of this specification has been described in terms of particular implementations, but other implementations can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

What is claimed is:

1. A computer-implemented method comprising:
receiving input from an advertising user specifying an advertisement that is associated with a particular landing page; and
automatically generating a key phrase for the advertisement, the key phrase being generated based on features extracted from the landing page and based on empirical statistics derived from a corpus comprising corpus key phrases and web pages corresponding to the respective corpus key phrases.

2. The method of claim 1, wherein the corpus key phrases in the corpus comprise key phrases for other advertisements and the corresponding web pages in the corpus comprise landing pages corresponding to the key phrases.

3. The method of claim 1, wherein the corpus key phrases comprise queries received by a search engine from users and the corresponding web pages in the corpus comprise web pages whose corresponding search results were presented by the search engine in response to the queries and then selected by the respective users.

4. The method of claim 1, further comprising automatically associating the generated key phrase with the advertisement in an advertising system.

5. The method of claim 1, further comprising presenting the generated key phrase to the advertising user.

6. A computer-implemented method comprising:
obtaining a corpus of key phrases, web pages, and click-through rates;
each key phrase providing access to one or more corresponding web pages;
each web page corresponding to a click-through rate, the click-through rate being a fraction of the number of times a hyperlink to the web page is presented to users that the hyperlink is selected by the users; and
the click-through rates being grouped into buckets;
extracting features from the web pages; and
obtaining a set of first empirical probabilities, a set of second empirical probabilities, and a mapping of features to key phrases:
each first empirical probability, \hat{P}(kⱼ|fᵢ), being a fraction of web pages with a particular feature fᵢ that correspond to a particular key phrase kⱼ;
each second empirical probability, \hat{P}(CTR_{b}|fᵢ∩kⱼ), being a fraction of web pages with a particular featured and reached through a particular key phrase kⱼ that correspond to a particular click-through rate bucket CTR_{b}; and
the mapping associating features and key phrases, each feature being associated with the respective key phrases corresponding to web pages containing the feature.

7. The method of claim 6, wherein the features are n-grams.

8. A computer-implemented method comprising:
receiving input from an advertising user specifying an advertisement that is associated with a particular landing page;
extracting a plurality of features from the landing page;
identifying a collection of key phrases corresponding to the plurality of features; and
scoring each identified key phrase of the collection, the scoring being at least in part based on one or more empirical probabilities derived from a corpus comprising web pages.

9. The method of claim 8, wherein scoring a key phrase comprises calculating a nested summation of an outer summation and an inner summation, comprising:
calculating the outer summation of one or more outer summands over the features, each outer summand for each feature being a product of the weight corresponding to the feature, a first empirical probability \hat{P}(kⱼ|fᵢ) for each key phrase kⱼ and each feature f, and the inner summation for the key phrase and the feature, wherein:
calculating the inner summation of one or more inner summands for the key phrase and the feature over click-through buckets, each inner summand being the product of a weight for the click-through bucket and a second empirical probability \hat{P}(CTR_{b}|fᵢ∩kⱼ) for the key phrase kⱼ, the feature fᵢ, and the click-through bucket CTB_{b}.

10. The method of claim 8, further comprising:
assigning corresponding weights to each feature of the plurality of features;
wherein the weight for each feature is based on the feature's font, color, location, or number of occurrences in the landing page.

11. The method of claim 8, wherein the collection of key phrases is identified using a mapping associating features and key phrases, each feature being associated with the respective key phrases corresponding to web pages containing the feature.

12. The method of claim 8, further comprising presenting the key phrase with the highest score to the advertising user.

13. The method of claim 8, further comprising automatically associating the key phrase with the highest score with the advertisement.

14. A computer program product, encoded on a computer-readable medium, operable to cause data processing apparatus to perform operations comprising:
receiving input from an advertising user specifying an advertisement that is associated with a particular landing page; and
automatically generating a key phrase for the advertisement, the key phrase being generated based on features extracted from the landing page and based on empirical statistics derived from a corpus comprising corpus key phrases and web pages corresponding to the respective corpus key phrases.

15. The computer program product of claim 14, wherein the corpus key phrases in the corpus comprise key phrases for other advertisements and the corresponding web pages in the corpus comprise landing pages corresponding to the key phrases.

16. The computer program product of claim 14, wherein the corpus key phrases in the corpus comprise queries received by a search engine from users and the corresponding web pages in the corpus comprise web pages whose addresses were presented by the search engine in response to the queries and then selected by the respective users.

17. The computer program product of claim 14, further operable to cause data processing apparatus to perform operations comprising automatically associating the generated key phrase with the advertisement in an advertising system.

18. The computer program product of claim 14, further operable to cause data processing apparatus to perform operations comprising presenting the generated key phrase to the advertising user.

19. A computer program product, encoded on a computer-readable medium, operable to cause data processing apparatus to perform operations comprising:
obtaining a corpus of key phrases, web pages, and click-through rates;
each key phrase providing access to one or more corresponding web pages;
each web page corresponding to a click-through rate, the click-through rate being a fraction of the number of times a hyperlink to the web page is presented to users that the hyperlink is selected by the users; and
the click-through rates being grouped into buckets;
extracting features from the web pages; and
obtaining a set of first empirical probabilities, a set of second empirical probabilities, and a mapping of features to key phrases:
each first empirical probability, \hat{P}(kⱼ|fᵢ), being a fraction of web pages with a particular feature fᵢ that correspond to a particular key phrase kⱼ;
each second empirical probability, \hat{P}(CTR_{b}|fᵢ∩kⱼ), being a fraction of web pages with a particular featured and reached through a particular key phrase kⱼ that correspond to a particular click-through rate bucket CTR_{b}; and
the mapping associating features and key phrases, each feature being associated with the respective key phrases corresponding to web pages containing the feature.

20. The computer program product of claim 19, wherein the features are n-grams.

21. A computer program product, encoded on a computer-readable medium, operable to cause data processing apparatus to perform operations comprising:
receiving input from an advertising user specifying an advertisement that is associated with a particular landing page;
extracting a plurality of features from the landing page;
identifying a collection of key phrases corresponding to the plurality of features; and
scoring each identified key phrase of the collection, the scoring being at least in part based on one or more empirical probabilities derived from a corpus comprising web pages.

22. The computer program product of claim 21, wherein scoring a key phrase comprises calculating a nested summation of an outer summation and an inner summation, comprising:
calculating the outer summation of one or more outer summands over the features, each outer summand for each feature being a product of the weight corresponding to the feature, a first empirical probability \hat{P}(kⱼ|fᵢ) for each key phrase kⱼ and each feature fᵢ, and the inner summation for the key phrase and the feature, wherein:
calculating the inner summation of one or more inner summands for the key phrase and the feature over click-through buckets, each inner summand being the product of a weight for the click-through bucket and a second empirical probability \hat{P}(CTR_{b}|fᵢ∩kⱼ) for the key phrase kⱼ, the feature fᵢ, and the click-through bucket CTB_{b}.

23. The computer program product of claim 21, further comprising:
assigning corresponding weights to each feature of the plurality of features;
wherein the weight for each feature is based on the feature's font, color, location, or number of occurrences in the landing page.

24. The computer program product of claim 21, wherein the collection of key phrases is identified using a mapping associating features and key phrases, each feature being associated with the respective key phrases corresponding to web pages containing the feature.

25. The computer program product of claim 21, further operable to cause data processing apparatus to perform operations comprising presenting the key phrase with the highest score to the advertising user.

26. The computer program product of claim 21, further operable to cause data processing apparatus to perform operations comprising automatically associating the key phrase with the highest score with the advertisement.

27. A system comprising:
means for receiving input from an advertising user specifying an advertisement that is associated with a particular landing page; and
means for automatically generating a key phrase for the advertisement, the key phrase being generated based on features extracted from the landing page and based on empirical statistics derived from a corpus comprising first key phrases and web pages corresponding to the respective first key phrases.
